(19) United States
(12) Patent Application Publication
(10) Pub. No.: US 2018/0131778 A1
(43) Pub. Date: May 10, 2018

(54) TIME ZONE NOTIFICATIONS FOR COMMUNICATION DEVICES

(71) Applicant: International Business Machines Corporation, Armonk, NY (US)

(72) Inventors: Itzhack Goldberg, Hadera (IL); Richard Hutzler, Tucson, AZ (US); Samuel Kallner, D.N. Menashe (IL); Neil Sondhi, Pilisborosjeno (HU)

(21) Appl. No.: 15/345,542

(22) Filed: Nov. 8, 2016

(51) Int. Cl. H04L 29/08; H04W 4/22; H04L 12/58; H04L 29/06; H04W 68/00; H04W 64/00; G06F 3/0484; G10L 15/22; G01S 19/13

(52) U.S. Cl. CPC H04L 67/18; H04W 4/22; H04L 51/38; H04L 51/20; G01S 19/13; H04W 68/00; H04W 64/00; G06F 3/04842; G10L 15/22; H04L 65/1069

(57) ABSTRACT

A method includes, responsive to receiving a request from a first user to establish an electronic communication with a second user, determining time zone information for the second user. Responsive to determining communication preferences exist for the second user, the method determines a notification procedure for the second user based on the communication preferences of the second user and the time zone information for the second user. The method sends the time zone information for the second user to the first user based on the notification procedure.

### BACKGROUND

The present invention relates generally to the field of electronic communications, and more particularly to managing electronic communications based on the location of a communication device.

Current communication devices, such as mobile phones, are tools utilized by individuals to communicate with one another from all over the world. A mass communication network across the world enables for an individual in one part of the world to immediately attempt to connect with another individual in another part of the world. With the broadening scope of businesses into various market locations, communications between employees located in these markets are commonly performed at various times throughout a given day. For example, an employee traveling on business in one part of world may communicate with an onsite employee located in a different part of the world, where the employee traveling on business may be located in a time zone substantially different from the onsite employee.

### SUMMARY

Embodiments of the present invention disclose a method, a computer program product, and a system for sending time zone information.

A computer-implemented method includes responsive to receiving a request from a first user to establish an electronic communication with a second user, determining, by one or more processors, time zone information for the second user; responsive to determining communication preferences exist for the second user, determining, by one or more processors, a notification procedure for the second user based on the communication preferences of the second user and the time zone information for the second user; and sending, by one or more processors, the time zone information for the second user to the first user based on the notification procedure.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a time zone notification program, on a server computer within the distributed data processing environment of FIG. 1, for query based location determination, in accordance with an embodiment of the present invention; and

FIG. 3 depicts a block diagram of components of the server computer executing the intelligent mapping program within the distributed data processing environment of FIG. 1, in accordance with an embodiment of the present invention.

### DETAILED DESCRIPTION

Embodiments in accordance with the present invention have the ability to receive a request for a first communication device to connect to a second communication device. Embodiments in accordance with the present invention have the ability to determine a time zone for the second communication device, where the second communication device is associated with a recipient of a communication. Responsive to determining the time zone of the second communication device, embodiments in accordance with the present invention have the ability to send the time zone of the second communication device to the first communication device, where the first communication device is associated with a caller attempting to connect with a recipient. Embodiments of the present invention provide a general location (i.e., time zone) for the second communication device to the first communication device, such that the general location does not impede on the privacy of the recipient of the communication.

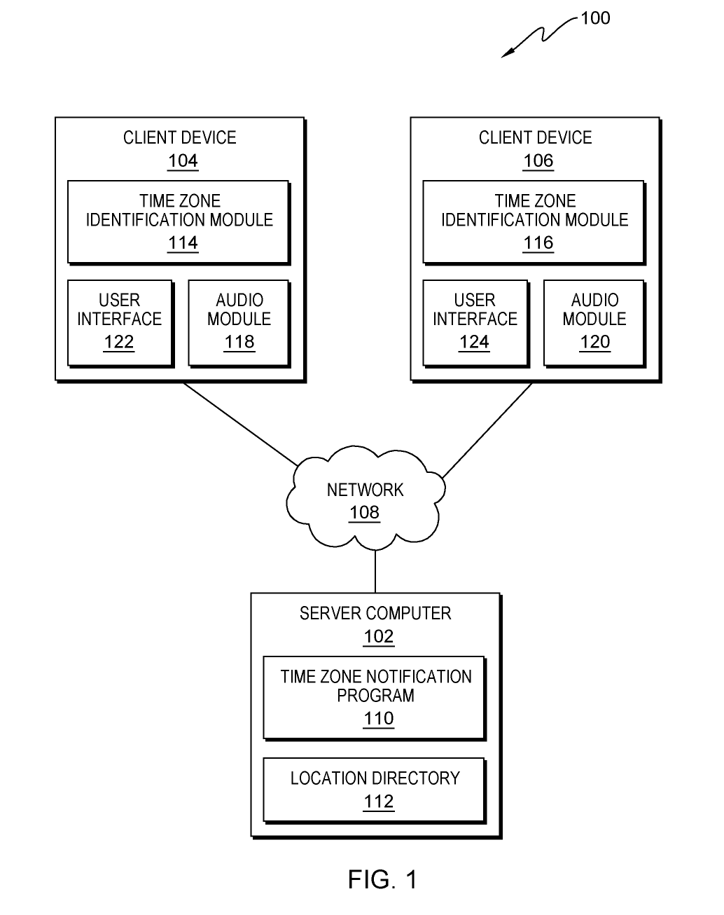

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes server computer 102, client device 104, and client device 106, all interconnected over network 108.

Server computer 102 may be a desktop computer, a laptop computer, a tablet computer, a specialized computer server, a smartphone, or any other computer system known in the art. In certain embodiments, server computer 102 represents a computer system utilizing clustered computers and components that act as a single pool of seamless resources when accessed through network 108, as is common in data centers and with cloud computing applications. In general, server computer 102 is representative of any programmable client device or combination of programmable client devices capable of executing machine-readable program instructions and communicating with other computer devices via a network. In this embodiment, server computer 102 includes time zone notification program 110 and location directory 112 accessible by client device 104 and client device 106, and any other client devices not illustrated in FIG. 1, via network 108.

Client device 104 and client device 106 may be, but is not limited to, a desktop computer, a landline phone, a laptop computer, a tablet computer, a radio headset, a mobile device connected headset, a smartphone, or any computer-based device capable of audible transmission. Client device 104 includes time zone identification module 114, audio module 118, and user interface 122. Client device 106 includes time zone identification module 116, audio module 120, and user interface 124. In general, client device 104 and 106 are representative of any programmable client device or combination of programmable client devices capable of executing machine-readable program instructions and communicating with users of other client devices via network 108. An audible transmission is any type of audio that can be electronically distributed, such as a phone call. For discussion purposes, in this embodiment a user of client device 104 is placing a phone call to connect with client device 106. In another embodiment, client device 104 and client device 106 are on a teleconference phone call and are attempting to connect with another user of another client device, not illustrated in FIG. 1.

In general, network 108 can be any combination of connections and protocols that will support communications between client device 104, client device 106, and server computer 102. Network 108 can include, for example, a local area network (LAN), a wide area network (WAN) such as the internet, a cellular network, or any combination of the preceding, and can further include wired, wireless, and/or fiber optic connections.

Time zone identification module 114 and 116 residing in client device 104 and 106, respectively, have the ability to provide a time zone for a user of client device 104 and 106. In this embodiment, time zone identification module 114 and 116 have the ability to determine a time zone (e.g., Central European Time (CET) or Eastern Time Zone (ET)) for client device 104 and 106, respectively, depending on whether client device 104 or 106 is a recipient of an attempted communication. Time zone identification module 114 and 116 have the ability to communicate with the Public Switch Telephone Network (PSTN), where the PSTN can tri-angulate a location for client device 104 or 106, identify a time zone for client device 104 or 106, and send time zone information for client device 104 and 106 to time zone identification module 114 and 116, depending on whether client device 104 or 106 is the recipient of an attempted communication. In other embodiments, time zone identification module 114 and 116 have the ability to obtain location information for client device 104 and 106, respectively. Time zone notification program 110 has the ability to utilize the location information for client device 104 and 106 to query location directory 112, via network 108, to obtain a physical location (e.g., hospital) associated with the location information for client device 104 and 106.

Time zone notification program 110 residing in server computer 102 has the ability to provide time zone information and in some embodiments, location information of client device 106 based on a query received through user interface (UI) 122 from a user of a client device 104. In one embodiment, a user of client device 104 attempts to establish a connection with a user of client device 106, wherein time zone notification program 110 intercepts the communication inquiry, via network 108, and accesses location directory 112 residing in server computer 102. Based on a user's communication preference, time zone notification program 110 may or may not release the user's time zone information.

In this particular embodiment, time zone notification program 110 enables for the user of client device 106 to select which users from a contact list (e.g., user of client device 104) are enabled to receive time zone information of client device 106. Additionally, the user of client device 106 can select certain time intervals for which time zone notification program 110 is to restrict or enable to receive time zone information of client device 106, as well as, restrict time zone information of client device 106 based on selected geographical regions. For example, the user of client device 106 can select to restrict or enable time zone notification program 110 to release time zone information for client device 106 between the hours of 8:00 AM to 5:00 PM. Depending on the communication preferences selected by the user of client device 106, client device 104 can either receive a notification to end the attempted communication or receive the time zone information for client device 106. Based on the time zone information of client device 106, the user of client device 104 may select whether or not to continue attempting to establish a communication with client device 106 via user interface 122. In an alternative embodiment, the user of client device 104 can utilize audio module 118 to select whether or not to continue attempting to establish the communication with client device 106. If the user of client device 104 selects to continue establishing the communication with client device 106, time zone notification program 110 initializes the call. If the user of client device 104 selects to not continue establishing the communication with client device 106, time zone notification program 110 terminates the attempt to establish the communication with client device 106. In one embodiment, time zone notification program 110 can be a web service accessible via network 108 to a user of client device 104 and client device 106. In another embodiment, time zone notification program 110 may be operated directly by a user of server computer 102.

Location directory 112 may be, but is not limited to, a web service, root directory, Public Switch Telephone Network (PSTN), Voice over Internet Protocol (VoIP), or any other interconnected networks known in the art that time zone notification program 110 can query for a location (e.g., a smart phone or computer) based on information received from client device 104 and client device 106.

User interface (UI) 122 residing in client device 104 displays information that any one of the processes of time zone notification program 110 may display to a user. User interface 122 can be, for example, a graphical user interface (GUI) or a web user interface (WUI) that displays text, documents, web browser windows, user options, application interfaces and instructions for operation. User interface 122 also has the ability to receive user inputs for time zone notification program 110. In this particular embodiment, a user of client device 104 attempts to establish a connection with a user of client device 106 via user interface 122, where time zone notification program 110 sends the time zone information of client device 106 to client device 104. Time zone notification program 110 has the ability to display the time zone information of client device 106 in user interface 122 on client device 104. Additionally, for this particular embodiment user interface 122 displays options for the user of client device 104 to manage the communication attempt.

Similar to user interface 122, user interface 124 on client device 106 displays information that any one of the processes of time zone notification program 110 may display to a user. User interface 124 also has the ability to receive user inputs for time zone notification program 110. In one embodiment, time zone notification program 110 can receive user preferences, where a user of client device 106 selects, via user interface 124, whether or not to enable other users (i.e., user of client device 104) to receive time zone information. Additionally, in this particular embodiment the user of client device 106 may select one or more specific users from a list of users to received time zone information.

Audio module 118 on client device 104 enables time zone notification program 110 to audibly communicate with the user of client device 106 and or any other client device. Audio module 120 on client device 106 enable time zone notification program 110 to audibly communicate with the user of client device 104 and or any other client device. Audio module 118 and audio module 120 can be, but are not limited to, a speaker, a microphone, or any other audio communication devices known in the art. In this particular embodiment, time zone notification program 110 prompts an option in user interface 122 with an option to either continue the communication with the user of client device 106 or terminate communication with the user of client device 106, either by touch or vocal command. Time zone notification program 110 can receive the touch command via user interface 122 or the voice command via audio module 118. In an additional embodiment, time zone notification program 110 can audibly project, via audio module 118, any one of the program functions in order to assist a visually impaired user. Similarly, audio module 120 on client device 106 may also project any one of the functions of time zone notification program 110.

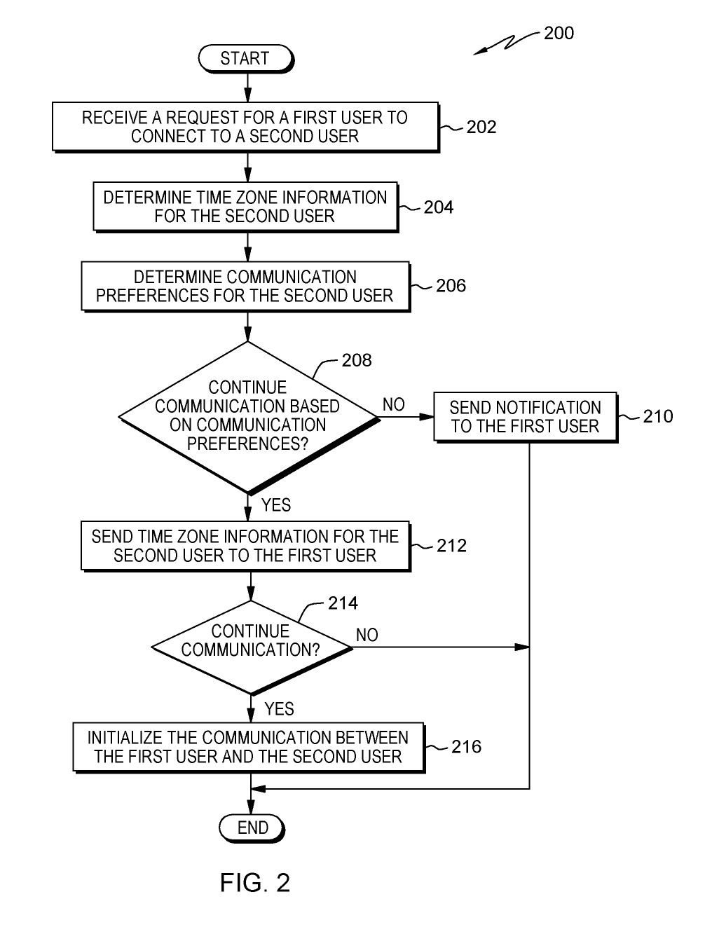

FIG. 2 is a flowchart depicting operational steps of time zone notification program 110, generally designated 200, on a server computer 102 within distributed data processing environment 100 of FIG. 1, for query based location determination, in accordance with an embodiment of the present invention.

Time zone notification program 110 receives a request for a first user to connect to a second user (202). In this particular embodiment, a user of client device 104 (i.e., a first user) is attempting to contact the user of client device 106 (i.e., a second user) via user interface 122 or audio module 118, where time zone notification program 110 intercepts the communication request. In one embodiment, a first user is attempting to contact a second user via a mobile phone, where prior to the initiation of the phone call, time zone notification program 110 intercepts the attempted phone call between the first user and the second user. Additionally, time zone notification program 110 can intercept an attempted phone call with a third user during a teleconference, where the first user and the second user are already present on the phone call. In another embodiment, a first user is attempting to connect to a second user via an internet based video conference service. In yet another embodiment, the first user is attempting to contact a second user via internet calling (i.e., a Wi-Fi network). In an alternative embodiment, a user of client device 106 is attempting to contact the user of client device 104 via user interface 124 or audio module 120, where time zone notification program 110 intercepts the communication request.

Time zone notification program 110 determines time zone information for the second user (204). In this particular embodiment, time zone notification program 110 communicates with time zone identification module 116 in client device 106 via a network 108, in order to determine the time zone (e.g., Central European Time) of the second user (i.e., recipient of the call). In one example, time zone identification module 116 has the ability to communicate with Public Switch Telephone Network (PSTN) to obtain time zone information. In another example, time zone identification module 116 has the ability to utilize a location identification application on client device 106 to determine a time zone based on the identified location provided by the location identification application. In alternative embodiment, time zone notification program 110 determines time zone information for both, the first user and the second user. Time zone notification program 110 can communicate with time zone identification module 114 and 116 to obtain time zone information for both client device 104 and 106, respectively.

In an alternative embodiment, time zone notification program 110 determines time zone information for the second user, along with location information for the first and the second user. The location information can include: a local time for a user, global positioning coordinates of a user, geographical data of a user, an address of a user, and any other form of communication information known in the art or any combination thereof. Time zone notification program 110 can associate global positioning coordinates of a user or an address of a user with a physical location (e.g., a hospital, a police station, or a school). For example, if a user is calling from a hospital time zone notification program 110 can determine based on the user's location information that the users call is coming from a hospital, and override any user preferences. In a different embodiment, time zone notification program 110 can store the global positioning coordinates and or any location information in a location directory, such as location directory 112. Additionally, time zone notification program 110 enables for the user to create communication preferences for each of the stored physical locations.

Time zone notification program 110 determines the communication preferences for the second user (206). In this particular embodiment, time zone notification program 110 receives the communication preferences prior to the first user attempting to communicate with the second user. In another embodiment, time zone notification program 110 receives the communication preferences in real-time. For example, subsequent to time zone notification program 110 intercepting the first user's contact attempt, time zone notification program 110 prompts the second user to select the communication preferences for this particular call on user interface 124 of client device 106. The second user can select which members in their contact list can receive time zone information for client device 106. Additionally, the second user can select certain time intervals and geographic locations to restrict time zone notification program 110 from sending the time zone information for client device 106. The second user's communication preferences are then stored in location directory 112, where time zone notification program 110 can access the communication preferences for the second user. In one embodiment, the second user can select the communication preferences for client device 106 through user interface 124. User interface 124 can be a mobile application, general device settings, a website/web service, touch-tone dialing, or any combination thereof. In another embodiment, the second user can use an audio module 120 to select the communication preferences for device 106. In anticipation of a phone call from client device 104, the user of client device 106 can preset the communication preferences for client device 106 and select the communication preferences using a mobile application conducted on user interface 124. The user of client device 106 can select to enable time zone notification program 110 to send time zone information of client device 106 to client device 104, but only between the hours of 8:00 AM and 3:00 PM.

In another embodiment, time zone notification program 110 enables for predetermined emergency contacts to automatically override any existing communication preferences for a particular user. For example, a user can select certain family members (i.e., spouse, significant other, sibling, etc.), work related contacts, physicians, hospitals, police stations, or any other contacts the user would like to select for an automatic override. In another example, each of the user's communication preferences for the user's contact list is defaulted to automatic override. In a different embodiment, time zone notification program 110 enables the user to select to change the override default settings to either automatically override the user's communication preferences or set the override default settings to automatically disable the override setting. In an additional embodiment, location directory 112 is linked to an emergency contact database, where time zone notification program 110 identifies emergency and first responder contact information and automatically overrides the user's communication preferences. In an additional embodiment, the user can manually enter the emergency contacts similar to entering the physical locations into location directory 112, as previously discussed. In another embodiment, each communication preference for the first user's contact list is defaulted to automatically override time zone notification program 110, where the override restricts time zone notification program 110 from intercepting the communication attempt. Time zone notification program 110 enables the user to select to change the override default settings to either automatically override the user's communication preferences or set the override default settings to automatically disable the override setting.

In an alternative embodiment, a first user may set preferences, for a predetermined emergency contact list on client device 104. The predetermined emergency contact list can automatically override time zone notification program 110. For example, a first user is traveling in Europe and is faced with an emergency and needs to call his family in North America. In one example, the first user would have predetermined contacts to automatically override time zone notification program 110, where time zone notification program 110 initializes the communication between the first and second user (216) rather than determining whether to continue the communication (214). In another example, the first user can specific particular time zones associated with the predetermined contacts for which time zone notification program 110 automatically initializes the communication between the first and the second user (216). In another embodiment, the first user can be presented with an option to override time zone notification program 110 in real time either through user interface 122 or audio module 118.

For example, a first user is attempting to call a second user via a mobile phone, where the second user is located in a time zone different from the first user. The second user sets the communication preferences to disable time zone notification program 110 from sharing the second user's current time zone information with the first user between the hours of 4:00 PM and 8:00 PM. As previously discussed, location directory 112 enables a user to store physical locations and establish communication preferences for the stored physical locations. For example, a user is traveling abroad and enters a hospital in a foreign region. Time zone notification program 110 may enable the user to save and store the physical location of the foreign hospital via global positioning coordinates, and time zone notification program 110 enables the user to store the communication preferences for the foreign hospital. In a different embodiment, time zone notification program 110 determines a physical location and stores the physical location utilizing an IP address from a wireless internet server (i.e. Wi-Fi) present at the physical location. Physical location and or physical location information can be, but is not limited to, a physical address, satellite positioning coordinates, cellular triangulation utilizing the public switched telephone network (PSTN), or any other location information system known in the art.

Time zone notification program 110 determines whether to continue the communication based on the communication preferences (208). In the event time zone notification program 110 determines to not continue the communication (“no” branch, 208), time zone notification program 110 sends a notification to the first user (210). In the event time zone notification program 110 determines to continue the communication (“yes” branch, 208), time zone notification program 110 sends time zone information for the second user to the first user (212). Based on the second user's communication preference time zone notification program 110 can access the second user's time zone information via client device 106. For example, if the second user's communication preference is set to restrict the release of the time zone information for the client device 106, then time zone notification program 110 will not share the time zone information for client device 106 with the first user.

Time zone notification program 110 sends a notification to the first user (210). In this particular embodiment, if the user of client device 106 communication preferences are set to restrict time zone notification program 110 from sending time zone information of client device 106, then time zone notification program 110 sends a notification to the first user to end the communication attempt with second user. The notification sent to the first user can be, but is not limited to, an audio message, a text display, a recorded message, an operator, an operating system, a particular tone, an image, or any combination thereof. For example, if the user of client device 106 has elected to restrict the time zone information of client device 106 associated with the second user, time zone notification program 110 sends the first user a pre-recorded message that the call is to terminate in a given amount of time (i.e., 5 seconds). In an additional embodiment, time zone notification program 110 displays either a standardized or custom text on user interface 122, notifying the first user that the communication attempt is to terminate. In an additional embodiment, time zone notification program 110 displays a notification to the first user that includes details of when the second user will be available for communication based on the determined time zone information from (204). For example, in addition to the standardized message notifying the first user that the communication attempt is about to be terminate, time zone notification program 110 includes a specific time frame, along with the notification, for the first user to attempt another communication with the second user.

Time zone notification program 110 sends time zone information for the second user to the first user (212). In this particular embodiment, time zone notification program 110 sends the time zone information of client device 106 associated with the second user to client device 104 associated with the first user. Time zone notification program 110 can send the time zone information for the second user to the first user via an automated voice system, text display, a private email or message, an image, or any combination thereof. In one embodiment, the time zone information is displayed in text format to a user of client device 104 via user interface 122. In one example, the user of client device 104 is attempting to contact the user of client device 106 for a video conference. The user of client device 104 launches a computer application supporting the video conference and attempts to contact client device 106. The communication preferences of time zone notification program 110 for client device 106 are set to enable time zone information of client device 106 be sent to client device 104. When client device 104 attempts to contact client device 106, time zone notification program 110 displays time zone information for the second user within the computer application supporting the video conference of client device 104.

In an alternative embodiment, a second user's current time zone is highlighted on a map and time zone notification program 110 displays the highlighted map on the first user's client device. For example, time zone notification program 110 accesses the time zone identification module 116 on the second user's client device 106, highlights the second user's current time zone region (e.g., Central European Time), and displays the entire map with the highlighted time zone region to the first user's via user interface 122. In another additional embodiment, time zone notification program 110 displays the current time of the second user's location to the first user along with the highlighted time zone region.

Time zone notification program 110 determines whether to continue the communication (214). In the event time zone notification program 110 determines to continue the communication (“yes” branch, 214), time zone notification program 110 initializes (216) the communication between the first user and the second user. In the event time zone notification program 110 determines to not continue the communication (“no” branch, 214), time zone notification program 110 does not initialize the communication and time zone notification program 110 ceases operations.

Subsequent to the first user obtaining the time zone information of the second user, time zone notification program 110 presents the first user with the option to either continue or terminate the communication attempt based on the time zone information provided for the second user. In one embodiment, when time zone notification program 110 presents the first user with the option to either continue or terminate the communication attempt with the second user, time zone notification program 110 provides a signal tone and enables the first user to make a decision before automatically terminating the communication attempt within a pre-determined amount of time (e.g., 10 seconds). In another embodiment, time zone notification program 110 provides an audio display with a prompted touch-tone menu. In an additional embodiment, the continuation decision appears on user interface 122 via personal computer program or mobile application.

Time zone notification program 110 initializes the communication between the first user and the second user (216). In this particular embodiment, subsequent to time zone notification program 110 determining to continue the communication between the first user and the second user, time zone notification program 110 initializes the communication between the first user and the second user by utilizing methods known in the art. In one embodiment, time zone notification program 110 displays a prompt to the first user's user interface 122, wherein the prompt includes the time zone information for the second user and an option to continue to establish the electronic communication. Subsequent to time zone notification program 110 receiving a selection from the first user to continue to establish the electronic communication, time zone notification program 110 initializes the electronic communication between the first user and the second user.

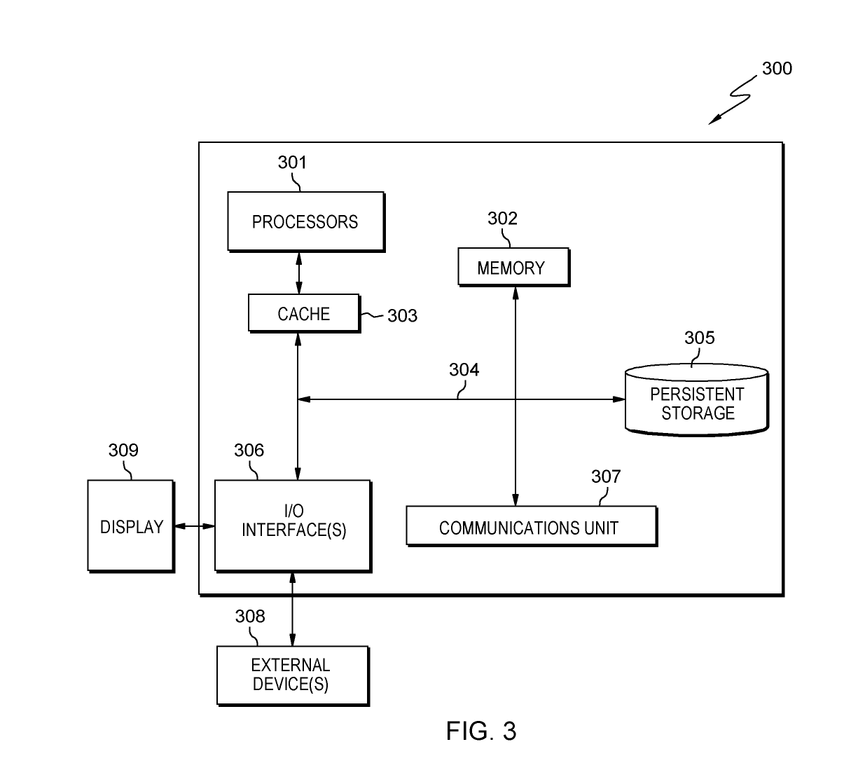

FIG. 3 depicts computer system 300, where server computer 102 represents an example of computer system 300 that includes time zone notification program 110. The computer system includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 enables for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
responsive to receiving a request from a first user to establish an electronic communication with a second user, determining, by one or more processors, time zone information for the second user;
responsive to determining communication preferences exist for the second user, determining, by one or more processors, a notification procedure for the second user based on the communication preferences of the second user and the time zone information for the second user; and
sending, by one or more processors, the time zone information for the second user to the first user based on the notification procedure.

2. The method of claim 1, further comprising:
displaying, by one or more processors, a prompt to the first user, wherein the prompt includes the time zone information for the second user and an option to continue to establish the electronic communication; and
responsive to receiving a selection from the first user to continue to establish the electronic communication, initializing, by one or more processors, the electronic communication between the first user and the second user.

3. The method of claim 1 further comprising:
prompting, by one or more processors, the first user utilizing an audible announcement, wherein the audible announcement includes the time zone information for the second user and an option to continue to establish the electronic communication
responsive to receiving an audible confirmation from the first user to establish the electronic communication, initializing, by one or more processors, the electronic communication between the first user and the second user.

4. The method of claim 1, wherein the communication preferences include one or more options to: enable sending the time zone information for the second user, restrict sending the time zone information for the second user, restrict sending the time zone information for the second user based on a time of day, and restrict sending the time zone information for the second user based on location information of the first user.

5. The method of claim 1, further comprising:
responsive to determining the communication preferences include an emergency contact, wherein the emergency contact is the first user, initializing, by one or more processors, the electronic communication between the first user and the second user.

6. The method of claim 1, wherein sending the time zone information for the second user to the first user based on the notification procedure further includes one or more of: a local time for the first and second user, global positioning coordinates for the first and second user, a geographical address for the first and second user, and an IP address for the first and second user.

7. The method of claim 1, further comprising:
responsive to determining to continue to establish the electronic communication with the second user, initializing, by one or more processors, the electronic communication between the first user and the second user.

8. A computer program product comprising:
one or more computer readable storage devices and program instructions stored on the one or more computer readable storage devices, the stored program instructions comprising:
program instructions to, responsive to receiving a request from a first user to establish an electronic communication with a second user, determine time zone information for the second user;
program instructions to, responsive to determining communication preferences exist for the second user, determine a notification procedure for the second user based on the communication preferences of the second user and the time zone information for the second user; and
program instructions to send the time zone information for the second user to the first user based on the notification procedure.

9. The computer program product of claim 8, further comprising program instructions, stored on the one or more computer readable storage media, which when executed by a processor, cause the processor to:
display a prompt to the first user, wherein the prompt includes the time zone information for the second user and an option to continue to establish the electronic communication; and
responsive to receiving a selection from the first user to continue to establish the electronic communication, initialize the electronic communication between the first user and the second user.

10. The computer program product of claim 8, further comprising program instructions, stored on the one or more computer readable storage media, which when executed by a processor, cause the processor to:
prompt the first user utilizing an audible announcement, wherein the audible announcement includes the time zone information for the second user and an option to continue to establish the electronic communication
responsive to receiving an audible confirmation from the first user to establish the electronic communication, initialize the electronic communication between the first user and the second user.

11. The computer program product of claim 8, wherein the communication preferences include one or more options to: enable sending the time zone information for the second user, restrict sending the time zone information for the second user, restrict sending the time zone information for the second user based on a time of day, and restrict sending the time zone information for the second user based on location information of the first user.

12. The computer program product of claim 8, further comprising program instructions, stored on the one or more computer readable storage media, which when executed by a processor, cause the processor to:
responsive to determining the communication preferences include an emergency contact, wherein the emergency contact is the first user, initialize the electronic communication between the first user and the second user.

13. The computer program product of claim 8, wherein sending the time zone information for the second user to the first user based on the notification procedure further includes one or more of: a local time for the first and second user, global positioning coordinates for the first and second user, a geographical address for the first and second user, and an IP address for the first and second user.

14. The computer program product of claim 8, further comprising program instructions, stored on the one or more computer readable storage media, which when executed by a processor, cause the processor to:
responsive to determining to continue to establish the electronic communication with the second user, initialize the electronic communication between the first user and the second user.

15. A computer system comprising:
one or more computer processors;
one or more computer readable storage devices;
program instructions stored on the one or more computer readable storage devices for execution by at least one of the one or more computer processors, the stored program instructions comprising:
program instructions to, responsive to receiving a request from a first user to establish an electronic communication with a second user, determine time zone information for the second user;
program instructions to, responsive to determining communication preferences exist for the second user, determine a notification procedure for the second user based on the communication preferences of the second user and the time zone information for the second user; and
program instructions to send the time zone information for the second user to the first user based on the notification procedure.

16. The computer system of claim 15, further comprising program instructions, stored on the one or more computer readable storage media, which when executed by a processor, cause the processor to:
display a prompt to the first user, wherein the prompt includes the time zone information for the second user and an option to continue to establish the electronic communication; and
responsive to receiving a selection from the first user to continue to establish the electronic communication, initialize the electronic communication between the first user and the second user.

17. The computer system of claim 15, further comprising program instructions, stored on the one or more computer readable storage media, which when executed by a processor, cause the processor to:
prompt the first user utilizing an audible announcement, wherein the audible announcement includes the time zone information for the second user and an option to continue to establish the electronic communication
responsive to receiving an audible confirmation from the first user to establish the electronic communication, initialize the electronic communication between the first user and the second user.

18. The computer system of claim 15, wherein the communication preferences include one or more options to: enable sending the time zone information for the second user, restrict sending the time zone information for the second user, restrict sending the time zone information for the second user based on a time of day, and restrict sending the time zone information for the second user based on location information of the first user.

19. The computer system of claim 15, further comprising program instructions, stored on the one or more computer readable storage media, which when executed by a processor, cause the processor to:
responsive to determining the communication preferences include an emergency contact, wherein the emergency contact is the first user, initialize the electronic communication between the first user and the second user.

20. The computer system of claim 15, further comprising program instructions, stored on the one or more computer readable storage media, which when executed by a processor, cause the processor to:
responsive to determining to continue to establish the electronic communication with the second user, initialize the electronic communication between the first user and the second user.
